(19) United States
(12) Patent Application Publication
(10) Pub. No.: US 2006/0266805 A1
(43) Pub. Date: Nov. 30, 2006

(54) Projection welding method and workpieces fabrication for projection welding

(76) Inventors: Song Cheh Ser, Singapore (SG); Weng How Leong, Singapore (SG)

Correspondence Address: MARTINE PENILLA & GENCARELLA, LLP, 710 LAKEWAY DRIVE, SUITE 200, SUNNYVALE, CA, 94085, US

(21) Appl. No.: 11/439,656

(22) Filed: May 23, 2006

(30) Foreign Application Priority Data
May 25, 2005 (SG) 200503361-8

(51) Int. Cl. A47J 36/02

(52) U.S. Cl. 228/101

(57) ABSTRACT

A method for fabricating a workpiece for projection welding is provided. One or more dimples are formed projecting outwardly from one surface of the workpiece, and a recess is formed surrounding the dimple, which is depressed inwardly into the surface. In a projection welding process, a second workpiece is placed with one side in contact with the dimples. Electric current is then applied through the workpieces to cause the dimple(s) to heat up until softened/melted. External pressure is added, so that to cause the first and second workpieces to move toward each other. The heated or molten dimples are then collapsed, and flow into the recess formed surrounding each dimple. As the /recess provides spaces or rooms for each of the collapsed dimples to flow into, the two workpieces can effectively be brought into contact and welded together throughout the joint interface, without a gap formed in between.

### TECHNICAL FIELD

The present invention relates to a welding method. In particular, it relates to a projection welding method for joining metal workpieces. It also related to workpieces fabricated for projection welding.

### BACKGROUND

Projection welding is a technology currently used in various manufacturing processes for joining two or more workpieces together. The advantages of projection welding include its versatility, the speed and ability to automate, the ability to make a number of welds simultaneously and minimization of marking on one side of joints in sheet materials.

In a conventional projection welding process, projections are designed and formed in one of the workpieces to be joined. These projections serve as electric current concentrators for the welding process. When the workpieces are mated together, these projections are the protruding points that first make contact with the other workpiece. As the power is cycled, the projections simultaneously carry the current and are welded.

Prior to applying the electric current, workpieces to be welded together are pre-treated so as to form the projections for welding. In one typical situation, one or more projections or embossed dimples are formed on one of the two workpieces, as shown in FIG. 1A. Dimple 12 is formed on one side of first workpiece 10 by punching from the opposite side. Thereafter, a second workpiece 20 is placed to contact dimple 12. When electric current is applied to workpieces 10 and 20, dimple 12 is heated and melted. Pressure is applied to workpieces 10 and 20 against each other. The molten dimple contacts to both workpieces 10 and 20, and hence produces a strong bond across the weld interface. Alternatively, the heated dimple 12 may be plastically deformed without being melted, and in contact with both workpieces to produces a strong bond.

One major problem of the projection welding method illustrated above is that, in order to allow the molten or plastically deformed dimple to flow and serve as the bond, there will be a space which exists between the two workpieces. When the two workpieces are welded together, a gap 30 is formed between the two workpieces, due the existence of the material of the collapsed dimples 22, as shown in FIG. 1B.

While this gap may be insignificant in certain industrial applications, however, this gap may affect the welding quality where precise industrial applications are involved, for example, in precise machinery industry. In disk drive industry, for example, parts or components of disk drives may not be joined together precisely to form an assembly, by using conventional projection welding technology mentioned above, due to the existence of the gap between two parts which significantly reduces the dimensional accuracy of the assembly.

Therefore, there exists a need to provide an improved projection welding method to meet the needs of the precision machining industry, so as to fully utilize the advantages of projection welding process to assemble workpieces together with desired dimensional accuracy.

### SUMMARY OF INVENTION

In accordance with a first aspect of the present invention, there is provided a method for fabricating a workpiece for projection welding. According to one embodiment, the workpiece is pressed between a punch and a die prior to welding. The punch has a ridge projecting outwardly from a base plane, with a recess formed within the ridge, which is formed inwardly into the base plane. Pressed by the punch and the die, deformation of workpiece occurs whereby a dimple is formed projecting outwardly from one surface of the workpiece, and a recess is formed surrounding the dimple, which is depressed inwardly into the surface. The workpiece can now be assembled to another workpiece by projection welding.

In accordance with another aspect of the present invention, there is provided a workpiece for projection welding. The workpiece has one or more dimples formed thereon, each dimple has a recess formed surround the dimple. The dimples are projected outwardly from a first surface of the workpiece. Each recess is depressed inwardly into the first surface.

In accordance with a further aspect of the present invention, there is provided a projection welding method of fabricating precision machine parts and/or assemblies, in which a gap between welded workpieces is eliminated.

In one embodiment, one or more dimples is/are formed on one surface of a first workpiece, which is/are projected outwardly from said surface. Surrounding each dimple is an annular groove or recess, which is formed inwardly into the surface. In the welding process, a second workpiece, with or without any dimple formed, is placed with one side in contact with the dimples of the first workpiece. Electric current is then applied through the workpieces, hence to cause the dimple(s) to heat up until softened or melted. External pressure is added, so that to cause the first and second workpieces to move toward each other. The heated or molten dimples are then collapsed to produce the bond between the first and second workpieces, and flow into the annular groove/recess formed surrounding each dimple. As the groove/recess provides spaces for each of the collapsed dimples to flow into, the two workpieces can effectively be brought into contact and bond with each other throughout the joint interface, without a gap formed in between.

### BRIEF DESCRIPTION OF THE DRAWINGS

These and other aspects and advantages of the present invention will be described in detail with reference to the accompanying drawings, in which:

FIGS. 1A and 1B are cross sectional views showing projection welding of two workpieces fabricated according to a conventional method;

FIG. 2 is a cross sectional view showing a workpiece fabricated for projection welding according to one embodiment of the present invention;

FIG. 3 is an enlarged view of FIG. 2;

FIG. 4 is a cross sectional view showing two workpieces to be joint together by projection welding according to one embodiment of the present invention;

FIG. 5 is a cross sectional view showing the two workpieces of FIG. 4 when welded together;

FIG. 6 is an enlarged view of FIG. 5 showing material flow of a dimple during welding;

FIG. 7 is an enlarged view of FIG. 5 showing two workpieces when welded together;

FIG. 8A is a cross sectional view showing three workpieces to be joined together by projection welding according to a further embodiment of the present invention;

FIG. 8B is an enlarged view of FIG. 8A showing material flow of dimples after upon welding;

FIG. 9 is a flow chart showing a method for fabricating workpieces for projection welding according to one embodiment of the present invention;

FIG. 10 is a flow chart showing a projection welding method according to one embodiment of the present invention.

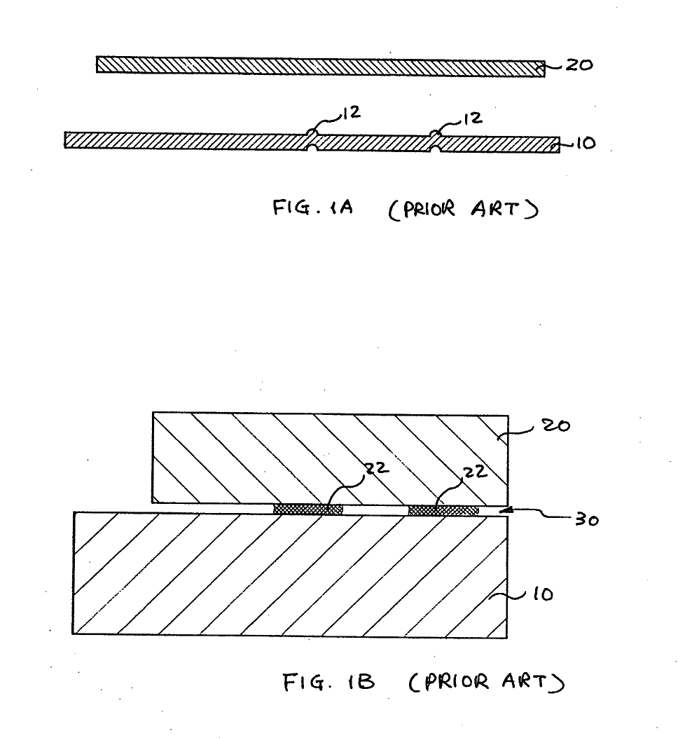

### DETAILED DESCRIPTION OF THE PREFERRED EMBODIMENTS

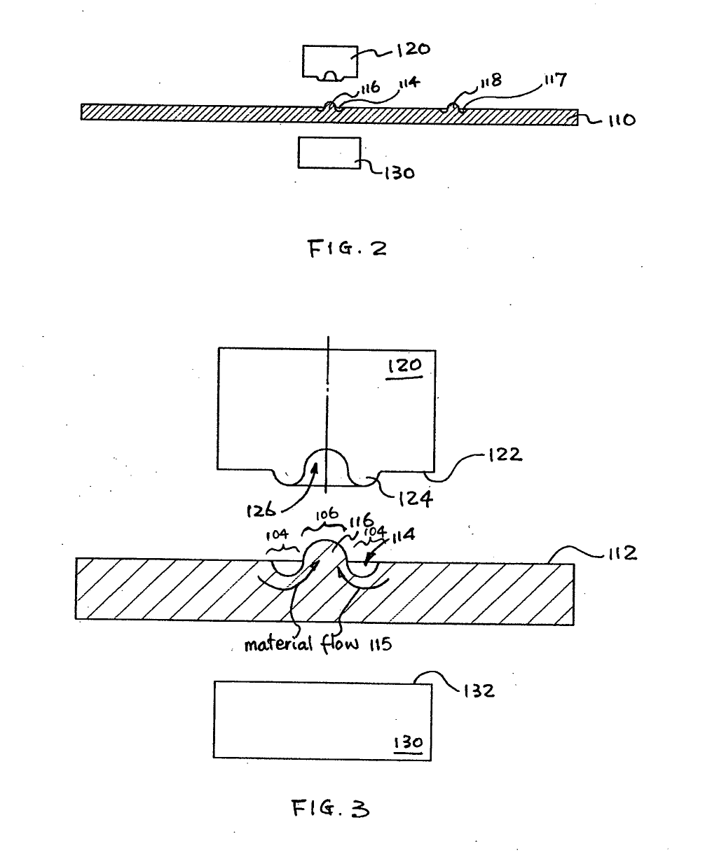

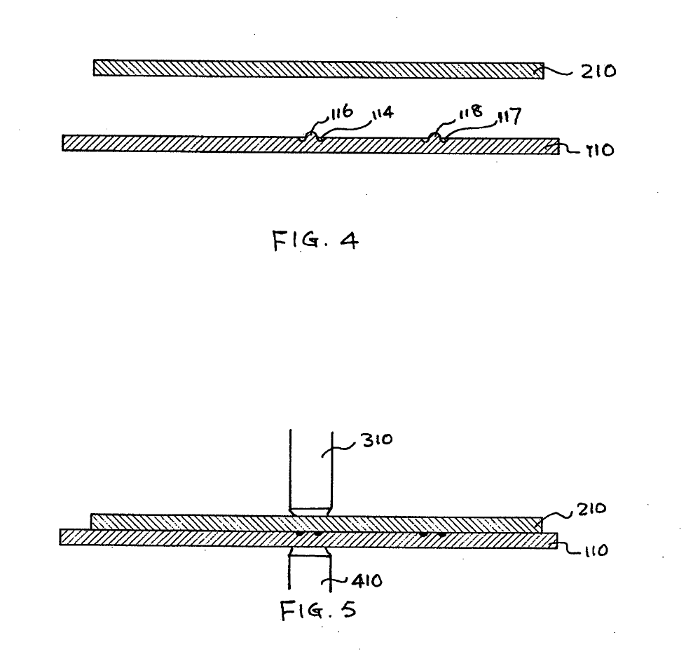

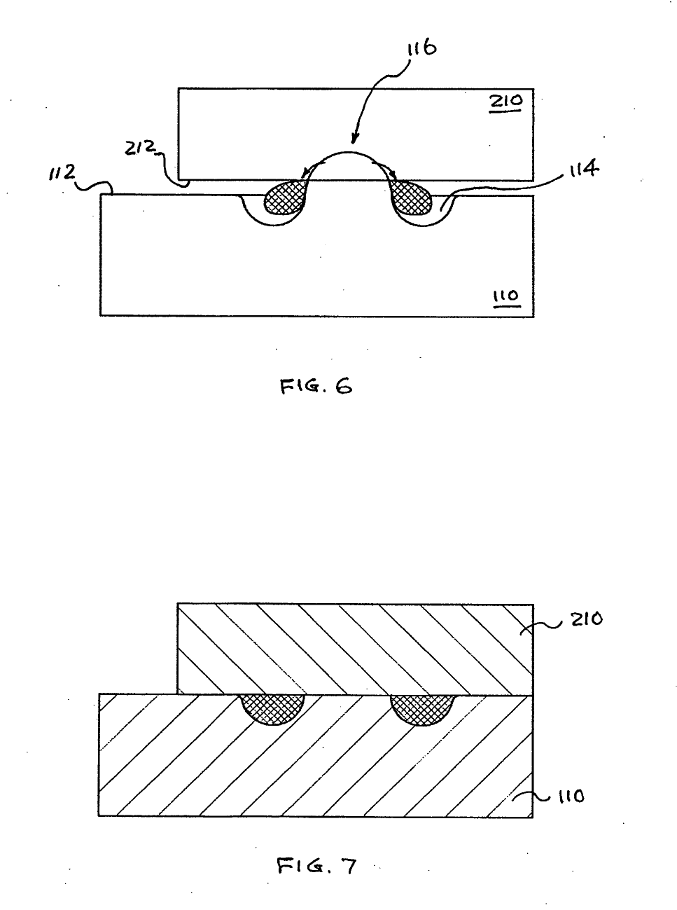

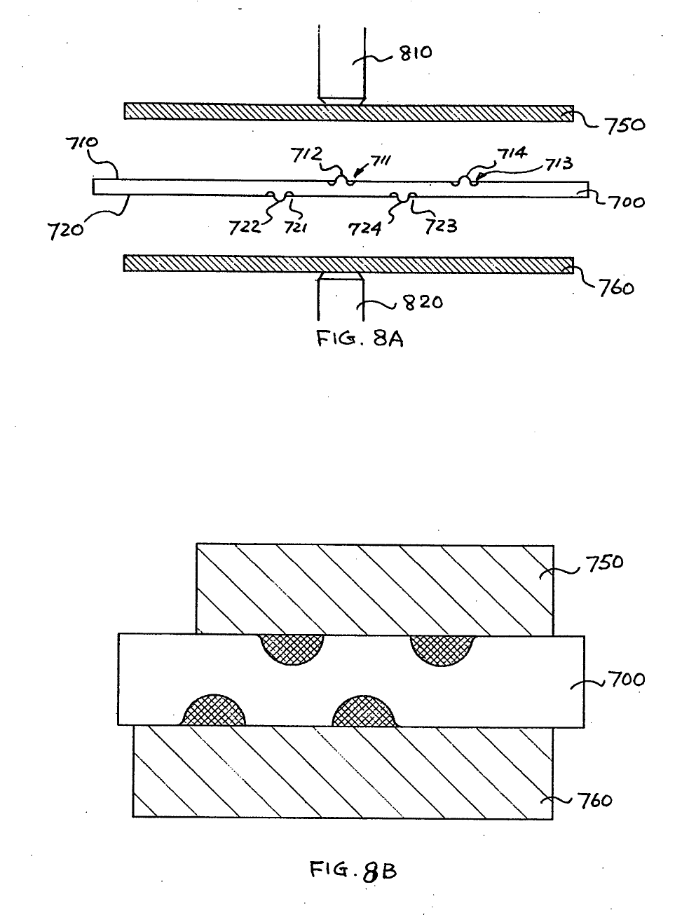

FIG. 2 and FIG. 3 show a workpiece 110 fabricated for projection welding. Workpiece 110 is firstly placed between a punch 120 and a die 130. Punch 120 has a ridge 124 projected outwardly from a base plane 122. A recess 126 is formed within ridge 124, which is depressed inwardly into base plane 122. Die 130 has a flat base plane 132.

In this embodiment, workpiece 110 is a sheet of metal which is plastically deformable under external pressure. It may be made of weldable material such as carbon steel, steel alloy or aluminum, for example. When punch 120 and die 130 move toward each other, workpiece 110 is pressed in between. By virtue of ridge 124 and recess 126, workpiece 110 is deformed such that a material flow 115 occurs from first segment 104 of workpiece 110, to a second segment 106. First dimple 116 is therefore formed at the second segment 106 projecting outwardly from a first surface 112 of workpiece 110. A recess, such as an annular groove 114 is also formed at the first segment 104 surrounding dimple 116, and depressed inwardly into first surface 112. Alternatively, the recess may be in other shapes, such as ellipse, square, triangle or polygon, etc. formed surrounding dimple 116. By way of example only, dimple 116 has a height of about 0.1 mm to about 0.5 mm, with an external diameter of about 0.5 mm to about 2 mm. A second dimple 118 may also be formed in a manner similar to that of first dimple 116, with an annular groove 117 formed surrounding second dimple 118. It should be appreciated that the number and locations of dimples may vary, which is to be determined by the welding requirements of workpieces, hence the present invention is applicable to workpieces requiring any number of dimples and recesses. The recesses may be formed at the same time when forming the dimple. Alternatively, the recesses and dimples may be formed in separate steps.

As shown in FIG. 4, workpiece 110, now referred to as first workpiece 110 having two dimples 116, 118 and two annular grooves 114, 117 surrounding respective dimples 116, 118 formed thereon as an example, is now ready for assembling with a second workpiece 210 by projection welding.

As shown in FIGS. 5, 6 and 7, an upper electrode 310 and a lower electrode 410 supply electric current through first and second workpieces 110 and 210. Dimples (only first dimple 116 is shown in FIG. 6 for illustration) are then heated. In one example, the dimples are heated to reach the melting temperature. In another example, the dimples are heated to a temperature below the melting temperature but in a range which causes the dimple to become softened. First and second workpieces 110 and 210 are then pressed against each other which, causes the dimple to collapse. As shown in FIG. 6, the collapsed dimple 116 then flows into annular groove 114. As a result, contact surfaces 112 and 212 of first and second workpieces 110 and 210 are brought into contact with each other. Since annular groove 114 provides a space to receive collapsed dimple 116, first and second workpieces 110 and 210 are now assembled together, having no gap formed in between, as shown in FIG. 7.

As shown in FIGS. 8A and 8B, three workpieces 700, 750 and 760 are desired to be assembled together. First groups of dimples 712, 714 are formed on first side 710 of center workpiece 700. Formed surrounding each dimple 712 and 714 there are annular grooves 711 and 713, respectively. A second group of dimples 722 and 724 are formed on second side 720, with annular grooves 721 and 723 formed surrounding respective dimple 722 and 724.

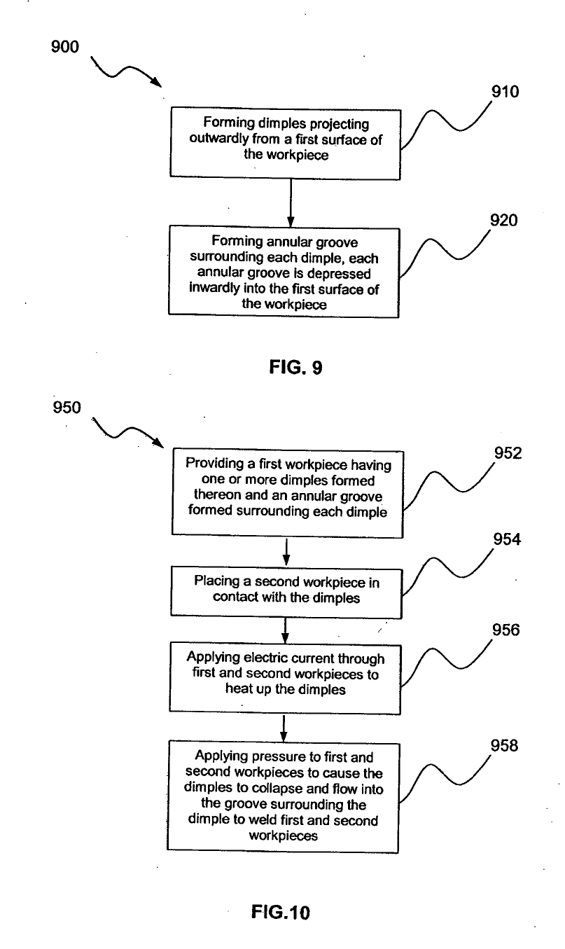

Upper and lower electrodes 810 and 820 then supply electric current to workpieces 700, 750 and 760. Dimples are then heated and when external pressure is added through workpieces 700, 750 and 760, all the dimples are collapsed. Material flow of each dimple is taken place, from the tip portion of each dimple to the annular groove surrounding each respective dimple. As the annular grooves provides spaces/room for receiving the flow of the collapsed dimples, the workpieces 700, 750 and 760 can be assembled with surfaces in contact with each other, having no gap formed in between, as shown in FIG. 9. The space capacity of the annular groove is preferably equal to or greater than the volume of the dimple, although this may not necessarily be the case.

FIG. 9 is a flow chart showing a method 900 for fabricating workpieces for projection welding according to one embodiment of the present invention. In a first block 910, one or more dimples are formed projecting outwardly from a first surface of the workpiece. In a second block 920, a recess such as an annular groove is formed surrounding each dimple, which is depressed inwardly into the first surface of the workpiece.

FIG. 10 is a flow chart showing a projection welding method 950 according to one embodiment of the present invention involving two workpieces. In a first block 952, a first workpiece is provided having at least one dimple formed thereon, which is projected outwardly from a first surface of the workpiece. Surrounding each of the at least one dimple, a recess such as an annular groove is formed, which is depressed inwardly into the first surface. In a next block 954, a second workpiece is brought into contact with the dimples of the first workpiece. In a next block 956, electric current is applied through first and second workpieces, and in block 958, carried out after block 956 or simultaneously with block 956, external pressure is applied to first and second workpieces so that to cause the workpieces to move toward each other, hence to cause dimple to collapse and flow into each respective annular groove, and weld the first and second workpieces together without gap in between.

1. A method of fabricating a workpiece for projection welding, comprising:
forming at least one dimple which is projected outwardly from a surface of the workpiece;
forming a recess surrounding the at least one dimple, wherein the recess is depressed inwardly into the surface.

2. The method as recited in claim 1, wherein the dimple and the recess are formed at the same time.

3. The method as recited in claim 2, further comprising pressing the workpiece to cause a material flow from a first segment to a second segment of the workpiece, wherein the first segment is to form the recess and the second segment is to form the dimple.

4. The method as recited in claim 1, wherein the recess has a space capacity equal to or greater than a volume of the dimple.

5. The method as recited in claim 1, wherein the surface is a first surface and the method further comprising:
forming at least one dimple which is projected outwardly from a second surface of the workpiece;
forming a recess surrounding the at least one dimple,
wherein the recess is depressed inwardly into the second surface.

6. A workpiece comprising:
a first surface;
a dimple projecting outwardly from the first surface, and
a recess surrounding the dimple,
wherein the recess is depressed inwardly into the first surface.

7. The workpiece as recited in claim 6, wherein the dimple is deformable.

8. The workpiece as recited in claim 7, wherein the dimple is to flow into the recess.

9. The workpiece as recited in claim 6, wherein the recess has a space capacity equal to or greater than a volume of the dimple.

10. A projection welding method comprising:
providing a first workpiece and a second workpiece, wherein the first workpiece having at least one dimple formed projecting outwardly from a first surface of the first workpiece and a recess formed surrounding the at least one dimple, wherein the recess is formed inwardly into the first surface;
placing the second workpiece in contact with the at least one dimple of the first workpiece;
applying an electric current through the first and second workpieces to heat the dimple; and
pressing the first and second workpieces to cause the dimple to collapse and flow into the recess,
wherein the at least one dimple bonds the first and second workpieces to each other.

11. The method as recited in claim 10, wherein three or more workpieces may be assembled together b the abovesaid method.

12. A projection welding method comprising:
providing a first workpiece having a first surface and a second surface opposite to the first surface, the first and second surfaces each having at least one dimple formed projecting outwardly and a recess formed surrounding the at least one dimple, wherein the recess is formed inwardly into the respective first and second surfaces;
placing a second workpiece in contact with the at least one dimple of the first workpiece projected from the first surface;
applying an electric current through the first and second workpieces to heat the at least one dimple;
pressing the first and second workpieces to cause the at least one dimple to collapse and flow into the recess,
wherein the at least one dimple bonds the first and second workpieces to each other.
